(19) United States
(12) Patent Application Publication
(10) Pub. No.: US 2026/0171737 A1
(43) Pub. Date: Jun. 18, 2026

(54) POWER CONNECTOR FOR A DATA COMMUNICATION SYSTEM

(71) Applicant: TE Connectivity Solutions GmbH, Schaffhausen (CH)

(72) Inventors: Noah R. Reitz, Middletown, PA (US); Richard Carreno, Middletown, PA (US); Nicholas Pease, Middletown, PA (US); Michael Menkhaus, Middletown, PA (US)

(21) Appl. No.: 18/978,613

(22) Filed: Dec. 12, 2024

(51) Int. Cl. H01R 25/14; H01R 13/04; H01R 13/11; H01R 13/24; H01R 13/631

(52) U.S. Cl. CPC H01R 25/142; H01R 13/04; H01R 13/111; H01R 13/2457; H01R 13/6315; H01R 2201/04

(57) ABSTRACT

A power connector includes a connector housing having a plug at a mating end at a front and a base at a terminating end at a rear. The plug is configured to be plugged into a busbar assembly and includes a slot between plug walls that receives a busbar of the busbar assembly. The power connector includes first and second power contacts received in corresponding contact channels each having a mating end in the slot to mate with busbar contacts of the busbar and a sockets at the terminating ends configured to receive corresponding power pins.

### BACKGROUND OF THE INVENTION

The subject matter herein relates generally to power connectors for a data communication system.

Data communication systems include various components within a data rack, such as a server or network system. The components may be arranged in shelves or trays within the data rack. Power is typically supplied to each of the equipment trays within the data rack by a power supply device, such as a busbar. A power connector is provided between the equipment tray and the power supply device. For example, power cables, extending from the power connector, may be routed to the equipment tray to supply power to the equipment tray. However, the power cables are typically large gauge wires, such as 10 gauge wires, which are difficult to route through the various components on the upper surface of the equipment tray. Moreover, the cable assemblies substantially block airflow over the equipment tray rearward of the power connector.

A need remains for improved connection between the equipment tray and the power supply device of a data communication system having improved thermal management.

### BRIEF DESCRIPTION OF THE INVENTION

In one embodiment, a power connector is provided and includes a connector housing that has a mating end at a front and a terminating end at a rear. The connector housing has a base at the terminating end and a plug, extending forward of the base, at the mating end. The plug is configured to be plugged into a busbar assembly. The plug includes a slot between a first plug wall and a second plug wall. The slot is configured to receive a busbar of the busbar assembly. The connector housing has contact channels through the base and extending to the slot of the plug. The power connector includes a first power contact received in the corresponding contact channel. The first power contact has a first mating end extending along the first plug wall into the slot to mate with a first busbar contact of the busbar. The first power contact has a first socket at the terminating end configured to receive a first power pin. The power connector includes a second power contact received in the corresponding contact channel. The second power contact has a second mating end extending along the second plug wall into the slot to mate with a second busbar contact of the busbar. The second power contact has a second socket at the terminating end configured to receive a second power pin.

In another embodiment, a data communication system is provided and includes a data rack having a rack space. The data communication system includes an equipment tray received in the rack space. The equipment tray includes a circuit board. The equipment tray includes a first power pin and a second power pin coupled to the circuit board. The data communication system includes a power supply device coupled to the data rack to supply power to the equipment tray. The power supply device includes a shroud forming a busbar chamber and a busbar received in the busbar chamber. The data communication system includes a power connector that includes a connector housing holding a first power contact and a second power contact. The connector housing has a mating end at a front and a terminating end at a rear. The connector housing has a base at the terminating end and a plug, extending forward of the base, at the mating end. The plug is configured to be plugged into a busbar assembly. The plug includes a slot between a first plug wall and a second plug wall. The slot is configured to receive a busbar of the busbar assembly. The connector housing has contact channels through the base and extending to the slot of the plug. The first power contact is received in the corresponding contact channel. The first power contact has a first mating end extending along the first plug wall into the slot to mate with a first busbar contact of the busbar. The first power contact has a first socket at the terminating end mated to the first power pin. The second power contact received in the corresponding contact channel. The second power contact has a second mating end extending along the second plug wall into the slot to mate with a second busbar contact of the busbar. The second power contact has a second socket at the terminating end mated to the second power pin.

In a further embodiment, a data communication system is provided and includes a data rack having a rack space. The data communication system includes an equipment tray received in the rack space. The equipment tray includes a circuit board. The equipment tray includes a first power pin and a second power pin coupled to the circuit board. The data communication system includes a power supply device coupled to the data rack to supply power to the equipment tray. The power supply device includes a shroud forming a busbar chamber and a busbar received in the busbar chamber. The data communication system includes a power connector that includes a connector housing holding a first power contact and a second power contact. The connector housing has a mating end at a front and a terminating end at a rear. The mating end of the connector housing forms an open rack power connector interface for mating with a busbar assembly. The first power contact has a first socket at the terminating end mated to the first power pin. The second power contact has a second socket at the terminating end mated to the second power pin.

### BRIEF DESCRIPTION OF THE DRAWINGS

FIG. 1 is a front view of a portion of a data communication system in accordance with an exemplary embodiment.

FIG. 2 is a rear view of a portion of the data communication system in accordance with an exemplary embodiment.

FIG. 3 is a rear perspective view of the electrical component in accordance with an exemplary embodiment.

FIG. 4 is a top view of the electrical component in accordance with an exemplary embodiment.

FIG. 5 illustrates a portion of the data communication system showing the power connector poised for mating with the power supply device in accordance with an exemplary embodiment.

FIG. 6 is a perspective view of a portion of the data communication system showing the power connector coupled to the power supply device in accordance with an exemplary embodiment.

FIG. 7 is a perspective view of the power connector in accordance with an exemplary embodiment.

FIG. 8 is a rear perspective view of the power connector in accordance with an exemplary embodiment.

FIG. 9 is a perspective view of a portion of the power connector showing the first and second power contacts in accordance with an exemplary embodiment.

FIG. 10 is a rear view of the power connector in accordance with an exemplary embodiment coupled to the first and second power pins.

FIG. 11 is a top view of the power connector in accordance with an exemplary embodiment coupled to the first and second power pins.

### DETAILED DESCRIPTION OF THE INVENTION

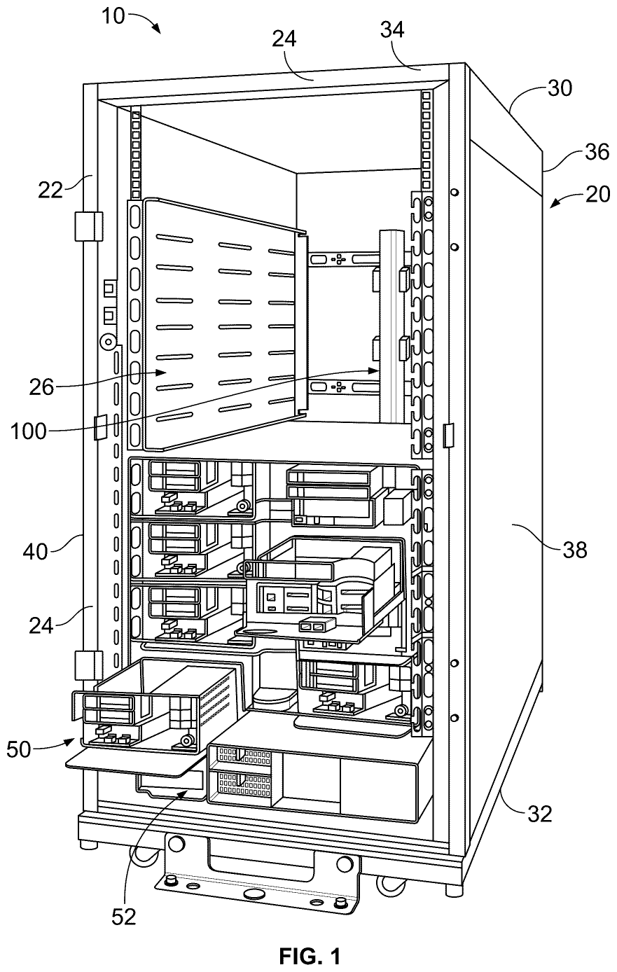

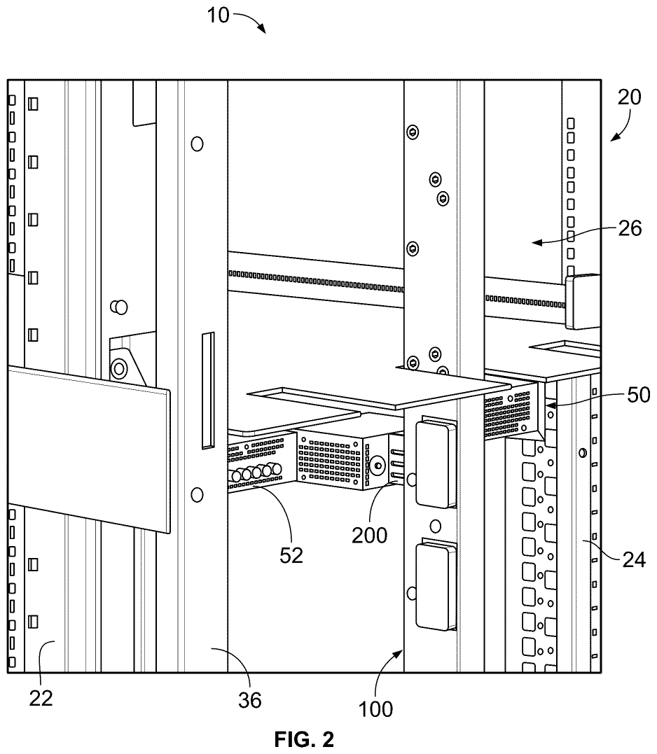

FIG. 1 is a front view of a portion of a data communication system 10 in accordance with an exemplary embodiment. FIG. 2 is a rear view of a portion of the data communication system 10 in accordance with an exemplary embodiment. In an exemplary embodiment, the data communication system 10 is a server rack housing network or server components. However, the data communication system 10 may be utilized in other applications in alternative embodiments.

The data communication system 10 includes a data rack 20 having a rack frame 22 holding electrical components 50. The rack frame 22 includes frame members 24, coupled together, forming the rack frame 22. The frame members 24 may include posts, beams, cross members, panels, walls or other components. The rack frame 22 may form a cabinet to surround the electrical components 50. The data rack 20 may be a server rack. The rack frame 22 of the data rack 20 forms a rack space 26, which may be subdivided or partitioned into multiple slots that receive corresponding electrical components 50. In various embodiments, the data rack 20 is generally rectangular or box-shaped. For example, the data rack 20 includes a top 30, a bottom 32, a front 34, a rear 36 and opposite sides 38, 40. The data rack 20 may be open at the front 34 to receive the electrical components 50. For example, the electrical components 50 may be plugged into the data rack 20 through the front 34.

The electrical components 50 are fixed to the data rack 20. For example, the electrical components 50 may be received in corresponding slots of the rack space 26 and secured to the rack frame 22. The electrical components 50 may be stacked in the data rack 20. In various embodiments, the electrical components 50 may include one or more patch panels, switches, servers, routers, firewalls, and the like. In an exemplary embodiment, the electrical components 50 include equipment trays 52 received in corresponding equipment slots of the rack frame 22. The equipment trays 52 may include compute trays, switch trays, power supply trays, and the like. The electrical components 50 may include cooling components, such as fans, to cool the equipment trays 52 or other components of the data communication system 10.

In an exemplary embodiment, the data communication system 10 includes a power supply device 100 configured to supply power to the electrical components 50. In the illustrated embodiment, the power supply device 100 is coupled to the rear 36 of the data rack 20. The power supply device 100 extends vertically behind the equipment slots of the rack frame 22 to allow electrical connection to each of the equipment trays 52 to transfer power to/from the various equipment trays 52. For example, when the equipment trays 52 are plugged into the data rack 20, the equipment trays 52 are electrically connected to the power supply device 100. In an exemplary embodiment, the equipment trays 52 include power connectors 200 (FIG. 2) coupled to the power supply device 100.

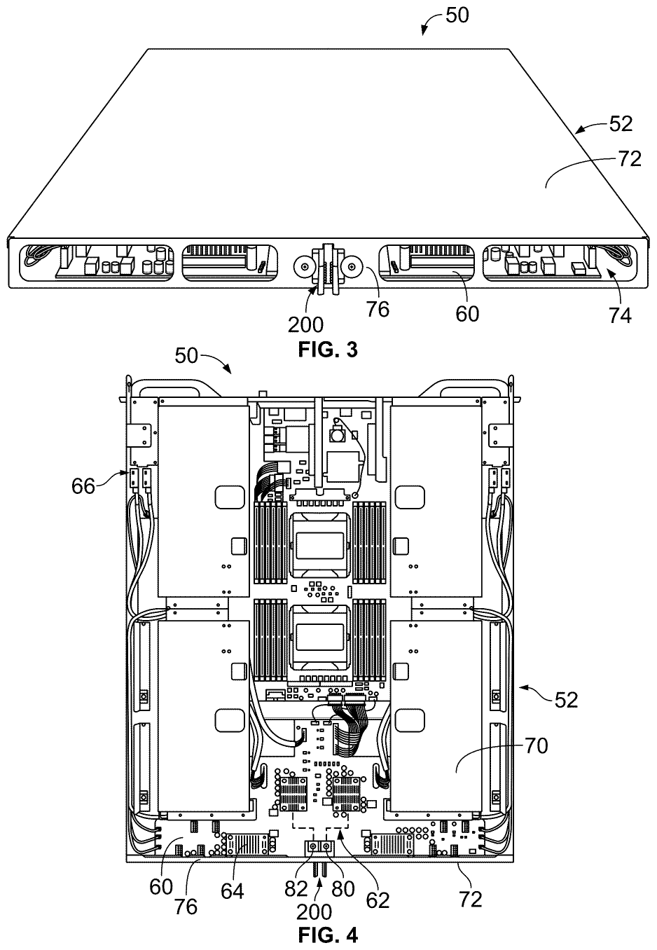

FIG. 3 is a rear perspective view of the electrical component 50 in accordance with an exemplary embodiment. FIG. 4 is a top view of the electrical component 50 in accordance with an exemplary embodiment. In an exemplary embodiment, the electrical component 50 includes the equipment tray 52. However, the subject matter herein is not limited to equipment racks. In an exemplary embodiment, the electrical component 50 includes the power connector 200, such as to supply power to the electrical component 50 or to supply power to the power supply device 100 from the electrical component 50 (for example, if the electrical component 50 is a power supply tray).

The electrical component 50 includes a circuit board 60. The power connector 200 is configured to be electrically connected to the circuit board 60, such as to a power circuit 62 of the circuit board 60. The electrical component 50 includes electronic devices 64 mounted to the circuit board 60. Any type of electronic devices 64 may be provided in the electrical component 50 depending on the particular application. The electrical component 50 may include thermal devices 66, such as heat sinks, fans, cold plates, or other types of thermal devices for thermal management of the components/devices on the circuit board 60. The electrical component 50 may include one or more electrical connectors 68, such as at the front, for mating with other components of the data communication system 10.

The electrical component 50 may include inner walls 70 providing dividers, covers or other structures for the electrical component 50. The electrical component may include outer walls 72 surrounding the exterior of the electrical component 50. The outer walls 72 form a shell or housing for the electrical component 50. The outer walls 72 may have openings 74, such as for airflow through the electrical component 50 for cooling of the components/devices in the interior of the outer walls 72. The power connector 200 may pass through an opening in one of the outer walls 72, such as at the rear, for connection to the power supply device 100. For example, the power connector 200 mounted to a rear panel 76. The panel 76 may be a chassis, a frame, a housing, or other component of the data communication system 10. In various embodiments, the panel 76 is electrically conductive and may be electrically grounded. For example, the panel 76 may be a piece of sheet metal. The power connector 200 may be electrically commoned with the panel 76. In an exemplary embodiment, the power connector 200 may be latchably coupled to the panel 76. For example, the power connector 200 includes one or more latching features that are latchably coupled to the panel 76.

In an exemplary embodiment, the electrical component 50 includes power pins, such as a first power pin 80 and a second power pin 82, coupled to the circuit board 60. The power pins 80, 82 are electrically connected to the power circuit 62 to supply power to the power circuit 62 (or receive power from the power circuit 62). The power pins 80, 82 are arranged near an edge of the circuit board 60, such as near the rear edge. The power pins 80, 82 extend from the upper surface of the circuit board 60. The power connector 200 is coupled to the power pins 80, 82. For example, the power connector 200 may be coupled to the power pins 80, 82 at a separable interface (for example, the power connector 200 may be mated to and unmated from the power pins 80, 82 without damaging the power connector 200 or the power pins 80, 82). In an exemplary embodiment, the power pins 80, 82 may be plugged into the power connector 200 (or the power connector 200 may be plugged onto the power pins 80, 82) during assembly. In an exemplary embodiment, the power pins 80, 82 occupy a very small area on the circuit board 60, leaving room for other components and/or leaving a space for cooling airflow around the power pins 80, 82 and the power connector 200. For example, compared to conventional systems that use large gauge power cables extending between the power connector and the circuit board, which are difficult to route and occupy a large area, thus restricting airflow, the interface between the power connector 200 and the power pins 80, 82 provides improved thermal management (for example, increased airflow) and improved component layout on the circuit board 60.

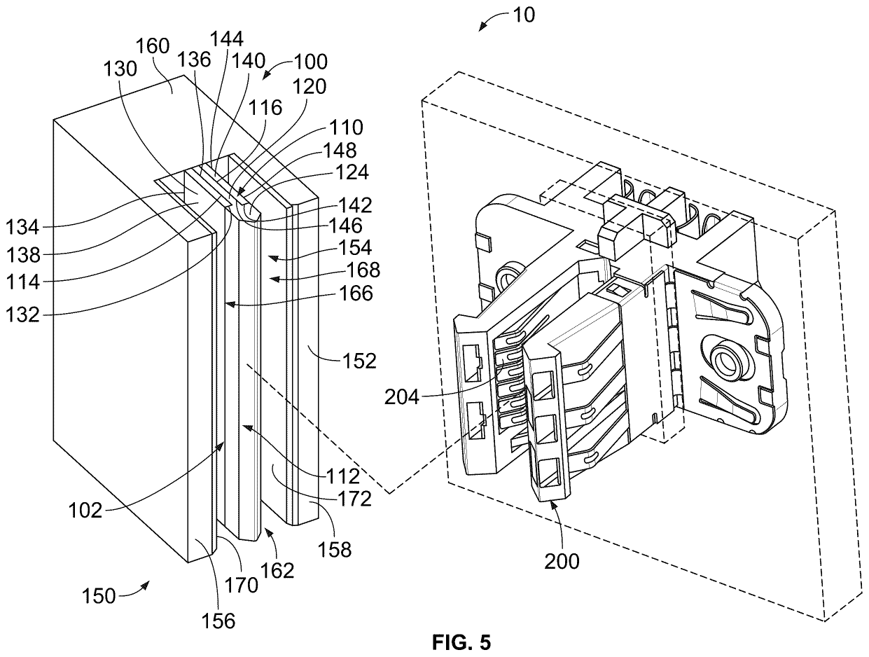

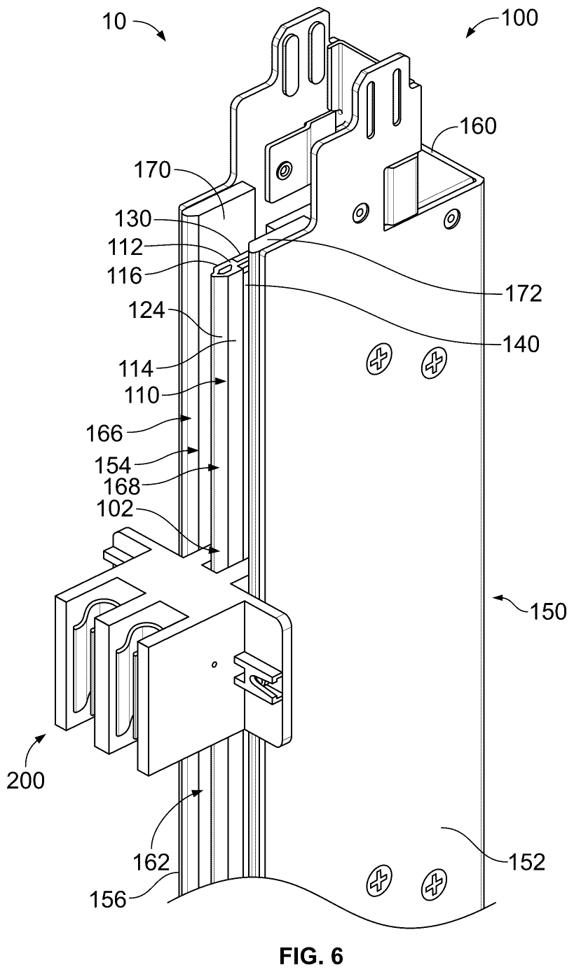

FIG. 5 illustrates a portion of the data communication system 10 showing the power connector 200 poised for mating with the power supply device 100 in accordance with an exemplary embodiment. FIG. 6 is a perspective view of a portion of the data communication system 10 showing the power connector 200 coupled to the power supply device 100 in accordance with an exemplary embodiment. The power connector 200 is coupled to the power supply device 100 at a mating zone 102. In an exemplary embodiment, multiple mating zones 102 may be located along the power supply device 100 to mate with multiple power connectors 200.

The power supply device 100 includes a busbar 110, a shroud 150 surrounding the busbar 110. The busbar 110 is electrically conductive in configured to collect and distribute electrical power for the data communication system 10, such as to distribute electrical power to the various equipment trays 52 (FIG. 1). The busbar 110 is used for high current power distribution along the power supply device. In an exemplary embodiment, the busbar 110 is configured to be mated to multiple power connectors 200 to transmit power between the various power connectors 200. One or more of the power connectors 200 may supply power to the busbar 110, such as from a power supply tray. One or more of the power connectors 200 may draw power from the busbar 110 to power the corresponding electrical component 50.

In an exemplary embodiment, the busbar 110 includes a support panel 112, a first busbar element 130 extending along a first side 114 of the support panel 112, and a second busbar element 140 extending along a second side 116 of the support panel 112. The support panel 112 is manufactured from a dielectric material, such as a plastic material. The busbar 110 may be a laminated structure with the first and second busbar elements 130, 140 laminated to the opposite sides of the support panel 112. The support panel 112 electrically isolates the first busbar element 130 from the second busbar element 140. The first busbar element 130 may be a positive or feed conductor for the busbar 110 in the second busbar element 140 may be a negative or returned conductor for the busbar 110.

The support panel 112 of includes a main panel 120 and a cap 124 at the distal end of the main panel 120. The first and second busbar elements 130, 140 are attached to opposite sides of the main panel 120. The cap 124 extends forward of the first and second busbar elements 130, 140. The cap 124 may be a touch safe feature to prevent inadvertent touching of the high current busbar 110. In the illustrated embodiment, the cap 124 is wedge-shaped at the distal end to guide mating of the power connector 200 with the busbar 110.

The first busbar element 130 is a metal conductor. For example, the first busbar element 130 may be a copper or aluminum conductor. In an exemplary embodiment, the first busbar element 130 is a conductive plate extending between a front 132 and the rear 134. The first busbar element 130 includes an inner surface 136 attached to the support panel 112 and an outer surface 138 opposite the inner surface 136. The power connector 200 is configured to electrically connect to the outer surface 138 of the first busbar element 130 at a mating interface. In an exemplary embodiment, multiple power connectors 200 may electrically connect to the first busbar element 130 at vertically staged mating interfaces along the height of the first busbar element 130. In various embodiments, the first busbar element 130 may be stamped and have different thicknesses. For example, the first busbar element 130 may be thinner at the front 132 and thicker at the rear 134.

The second busbar element 140 is a metal conductor. For example, the second busbar element 140 may be a copper or aluminum conductor. In an exemplary embodiment, the second busbar element 140 is a conductive plate extending between a front 142 and the rear 144. The second busbar element 140 includes an inner surface 146 attached to the support panel 112 and an outer surface 148 opposite the inner surface 146. The support panel 112 is located between the inner surfaces 136, 146 of the first and second busbar elements 130, 140. The power connector 200 is configured to electrically connect to the outer surface 148 of the second busbar element 140 at a mating interface. In an exemplary embodiment, multiple power connectors 200 may electrically connect to the second busbar element 140 at vertically staged mating interfaces along the height of the second busbar element 140. In various embodiments, the second busbar element 140 may be stamped and have different thicknesses. For example, the second busbar element 140 may be thinner at the front 142 and thicker at the rear 144.

The shroud 150 is used to support and/or surround the busbar 110 to isolate the busbar 110 and prevent inadvertent touching of the high current busbar 110 to prevent damage and/or injury. The shroud 150 includes a plurality of shroud walls 152 that form a busbar chamber 154 that receives the busbar 110. In an exemplary embodiment, the shroud walls 152 are stamped and formed from a metal sheet into a predetermined shape. In an exemplary embodiment, the shroud 150 is C-shaped including sides extending between an open end and a closed-end. The shroud 150 is configured to extend vertically along the rear of the data rack 20 to interface with the equipment trays 52 plugged into the data rack 20.

In an exemplary embodiment, the shroud walls 152 to include a first side wall 156, a second side wall 158, and an end wall 160 extending between the first and second side walls 156, 158. A shroud opening 162 is located opposite the end wall 160 between the first and second side walls 156, 158. In the illustrated embodiment, the shroud opening 162 is located at the front of the shroud 150 and the end wall 160 is located at the rear of the shroud 150. The shroud opening 162 is configured to receive the power connector 200. For example, the mating end of the power connector 200 may be plugged into the shroud opening 162 to electrically connect to the busbar 110.

The busbar 110 is configured to be positioned generally in the center of the busbar chamber 154. For example, the busbar 110 may be generally centered between the first side wall 156 and the second side wall 158. In an exemplary embodiment, first and second gaps 166, 168 are formed between the first and second busbar elements 130, 140 and the corresponding first and second side walls 156, 158. The mating end of the power connector 200 is configured to be received in the first and second gaps 166, 168 to electrically connect power terminals of the power connector 200 two the first and second busbar elements 130, 140.

In an exemplary embodiment, the shroud 150 includes ground terminals 170, 172 along the first and second side walls 156, 158 at the front of the shroud 150 to electrically connect to the power connector 200. The ground terminals 170, 172 extend vertically along the shroud 150. The ground terminals 170, 172 may be located immediately rearward of the shroud opening 162. The ground terminals 170, 172 may be electrically connected to ground contacts of the power connector 200 when the power connector 200 is plugged into the power supply device 100.

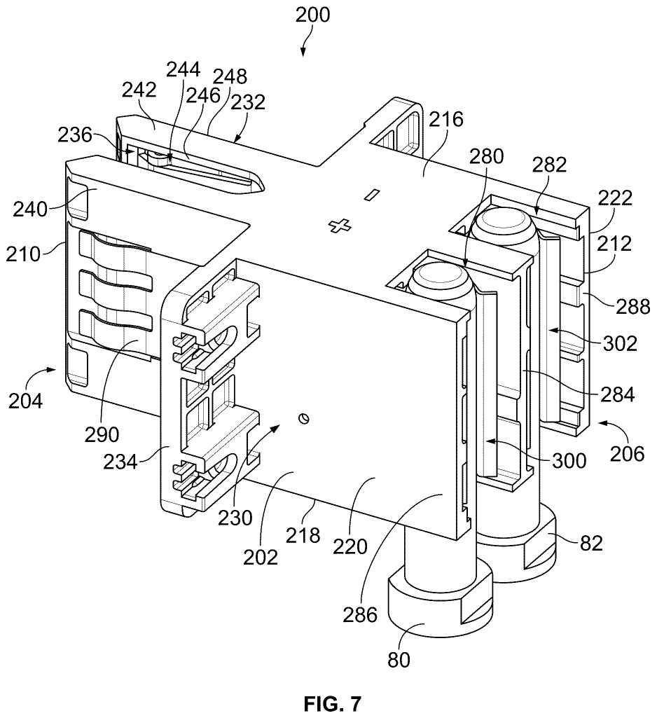

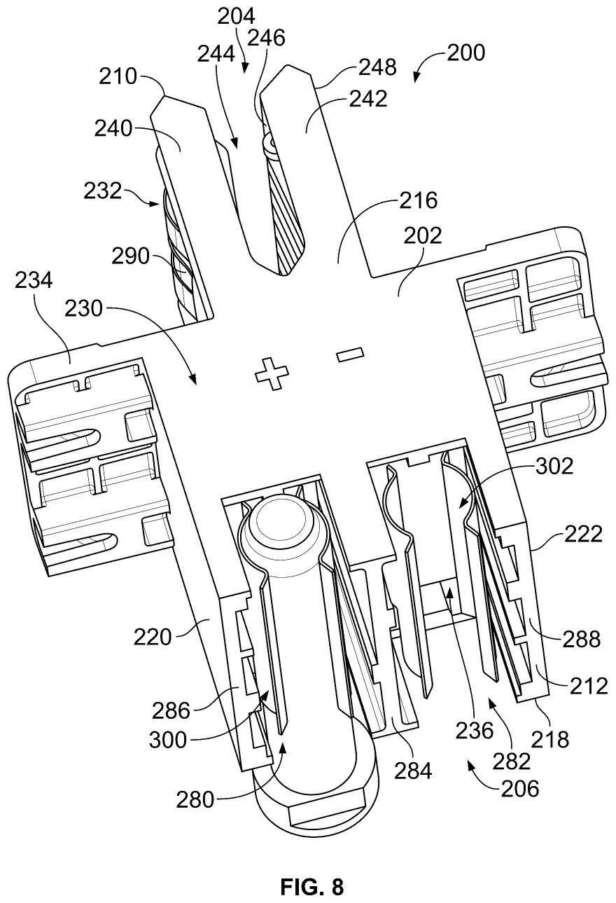

FIG. 7 is a perspective view of the power connector 200 in accordance with an exemplary embodiment. FIG. 8 is a rear perspective view of the power connector 200 in accordance with an exemplary embodiment. FIG. 7 shows the power connector 200 coupled to the first and second power pins 80, 82. FIG. 8 shows the power connector 200 coupled to the first power pin 80 with the second power pin 82 removed to illustrate internal components of the power connector 200.

The power connector 200 includes a connector housing 202 holding a first power contact 300 and a second power contact 302. The first and second power contacts 300, 302 are configured to be electrically connected to the first and second power pins 80, 82. In an exemplary embodiment, the first and second power contacts 300, 302 may be coupled to the power pins 80, 82 at separable interfaces. For example, the power pins 80, 82 may be plugged into the power connector 200 (or the power connector 200 may be plugged onto the power pins 80, 82) to mate the first and second power contacts 300, 302 and the power pins 80, 82 during assembly.

The first and second power contacts 300, 302 are configured to be electrically connected to the power supply device 100 (shown in FIG. 5). For example, the power contacts 300, 302 are configured to be electrically connected to the first and second busbar elements 130, 140 of the busbar 110. In an exemplary embodiment, each power contact 300, 302 includes a mating end and a terminating end opposite the mating end. The mating end may include spring beams or other types of contacts defining a mating interface for mating with the busbar 110. The terminating end includes clamps or other type of spring elements configured to be terminated to the power pins 80, 82 at the separable interfaces.

The connector housing 202 includes a front 210 and a rear 212. The front 210 defines a mating end 206 configured to be mated with the busbar 110. The rear 212 defines a terminating end 204 configured to be electrically connected to the power pins 80, 82. The connector housing 202 includes a top 216 or a bottom 218. The connector housing 202 includes a first side 220 and a second side 222. In an exemplary embodiment, the connector housing 202 has a footprint defined by the bottom 218. For example, the footprint is defined between the front 210 and the rear 212 and between the first side 220 and the second side 222. In an exemplary embodiment, the components of the power connector 200 are contained within the footprint. For example, no portion of the power connector 200 extends beyond the footprint. The first and second power contacts 300, 302 are contained within the footprint. The power pins 80, 82 are located within the footprint. For example, the footprint completely encloses the first and second power pins 80, 82. For example, the connector housing 202 extends forward of the first and second power pins 80, 82, rearward of the first and second power pins 80, 82, to the right side of the first and second power pins 80, 82, and to the left side of the first and second power pins 80, 82.

In an exemplary embodiment, the connector housing 202 includes a base 230 at the rear 212 and a plug 232 at the front 210. The connector housing 202 includes a flange 234 extending from the base 230. In various embodiments, the flange 234 may extend from the base 230 at the sides 220, 222. In other various embodiments, the flange 234 may extend from the base 230 at the top 216 and/or the bottom 218. The flange 234 is used for mounting the power connector 200 to the panel 76. For example, the flange 234 may face the rear surface of the panel 76. The base 230 is located rearward of the flange 234, and is thus configured to be located behind the panel 76. The plug 232 extends forward of the flange 234, and thus is configured to be located forward of the panel 76. For example, the plug 232 is configured to extend through the panel opening for mating with the busbar 110.

In an exemplary embodiment, the connector housing 202 includes contact channels 236 that receive the power contacts 300, 302. The contact channels 236 extend into the base 230 and into the plug 232. The power contacts 300, 302 are configured to be terminated to the power pins 80, 82 in the base portion of the contact channels 236. The power contacts 300, 302 are configured to be mated with the busbar 110 in the plug portion of the contact channels 236.

In an exemplary embodiment, the plug 232 includes a first plug wall 240 and a second plug wall 242 forming a slot 244 therebetween. Each of the plug walls 240, 242 include an interior surface 246 and an exterior surface 248. The interior surface 246 faces the slot 244. The slot 244 is open at the front 210 to receive the busbar 110. The power contacts 300, 302 are exposed within the slot 244 for mating with the corresponding first and second busbar contacts 132, 134 of the busbar 110. For example, the power contacts 300, 302 extend along the interior surfaces 246 of the corresponding plug walls 240, 242. In the illustrated embodiment, the slot 244 extends vertically from the top 216 to the bottom 218. For example, the slot 244 is open at the top 216 and open at the bottom 218. The slot 244 may have other shapes in alternative embodiments. In other alternative embodiments, a plurality of the slots 244 may be provided, such as individual slots for each of the power contacts 300, 302. In the illustrated embodiment, the plug walls 240, 242 are oriented vertically and provided at the first side 220 and the second side 222 of the plug 232. Additional plug walls may be provided in alternative embodiments.

In an exemplary embodiment, the power connector 200 includes ground contacts 290 coupled to the first plug wall 240 and the second plug wall 242. For example, the ground contacts 290 extend along the exterior surface 248 of the plug walls 240, 242 for mating with the ground terminals 170, 172. The ground contacts 290 are configured to be electrically connected to the panel 76. For example, the ground contacts 290 are used to electrically common the panel 76 and the ground terminals 170, 172 of the busbar assembly. The ground contacts 290 are electrically conductive. In an exemplary embodiment, the ground contacts 290 are stamped and formed from a metal sheet. The ground contacts 290 may include spring fingers that are deflectable to interface with the panel 76 and/or the ground terminals 170, 172.

In an exemplary embodiment, the base 230 includes first and second windows 280, 282 at the terminating end 204. A separating wall 284 is located between the first and second windows 280, 282. Outer walls 286, 288 are located at the outer sides of the first and second windows 280, 282 respectively. The first and second windows 280, 282 are located between the separating wall 284 and the outer walls 286, 288, respectively. When assembled, the terminating ends of the first and second power contacts 300, 302 are located in the first and second windows 280, 282. The first and second windows 280, 282 receive the first and second power pins 80, 82, respectively. For example, the first and second power pins 80, 82 are mated to the first and second power contacts 300, 302 in the first and second windows 280, 282. In an exemplary embodiment, the first and second windows 280, 282 are open at the top 216 and the bottom 218 of the connector housing 202 to allow the first and second power pins 80, 82 to extend from the top 216 and the bottom 218. In an exemplary embodiment, the first and second windows 280, 282 are open at the rear 212 to receive the first and second power pins 80, 82 into the first and second windows 280, 282 through the rear 212 in a plugging direction.

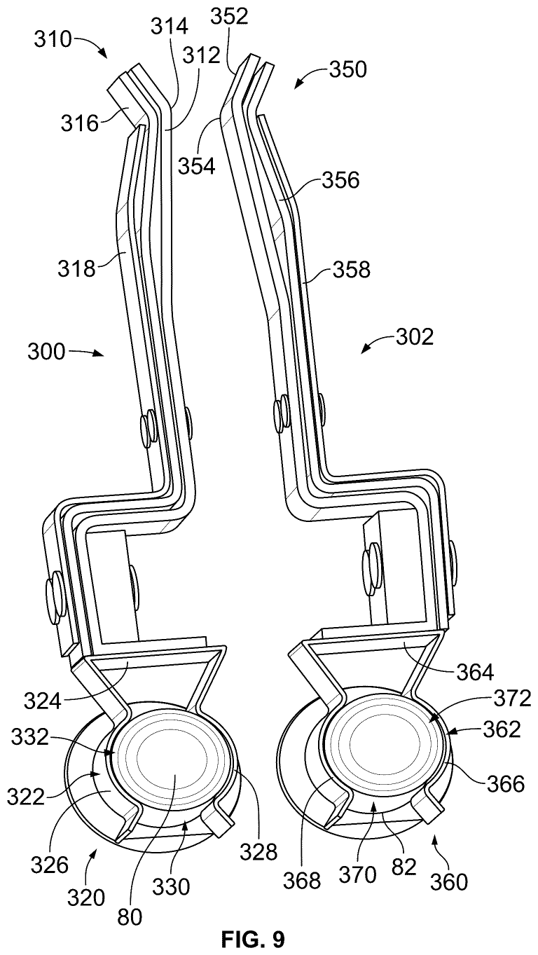

With additional reference to FIG. 9, which is a perspective view of a portion of the power connector 200 showing the first and second power contacts 300, 302 in accordance with an exemplary embodiment, the power contacts 300, 302 extend between the mating end 206 and the terminating end 204 of the connector housing 202.

In an exemplary embodiment, the first power contact 300 is a stamped and formed contact. The first power contact 300 may be a multi-piece contact, such as having multiple stamped and formed parts that are mechanically and/or electrically connected together. The first power contact 300 includes a first mating end 310 and a first terminating end 320. The first power contact 300 includes spring beams 312, or other types of contacts, defining a mating interface 314 for mating with the busbar 110. The mating interface 314 may be provided proximate to the distal ends of the spring beams 312. The first power contact 300 may include one or more support contacts, such as an inner support contact 316 and an outer support contact 318 providing support for the spring beams 312. The inner support contact 316 and/or the outer support contact 318 may be connected by welding, soldering, conductive adhesive, fasteners, rivets, or other connecting techniques. The inner support contact 316 and/or the outer support contact 318 may have different thicknesses than the spring beams 312. The inner support contact 316 and/or the outer support contact 318 may have different lengths than the spring beams 312.

In an exemplary embodiment, the first power contact 300 includes a first socket 322 at the first terminating end 320. The first socket 322 receives the first power pin 80. In an exemplary embodiment, the first socket 322 is a separate part from the spring beam 312. For example, the first socket 322 may be mechanically and electrically connected to the spring beam 312, such as by welding, soldering, fastening, or attaching by other processes. In an exemplary embodiment, the socket 322 is a stamped and formed part. The socket 322 is stamped from a piece of sheet metal and may have a thickness selected to have a particular current rating and/or selected to have certain resiliency characteristics, such as to have a particular clamping force to ensure mechanical and electrical connection to the first power pin 80.

The first socket 322 includes a base 324 and first clamp arms 326, 328 extending from the base 324. The base 324 extends from the spring beam 312. For example, the base 324 may be coupled (for example, welded, soldered, fastened, or otherwise connected to the spring beam 312) to the spring beam 312. The first socket 322 forms a space or gap 330 between the first clamp arms 326, 328 configured to receive the first power pin 80. The gap 330 is located rearward of the base 324.

The first socket 322 forms a first pocket 332 in the gap 330 configured to receive the first power pin 80. The first pocket 332 may be sized and shaped to receive the first power pin 80. For example, the first pocket 332 may be circular or oval shaped to form a space configured to receive and retain the first power pin 80. The distal ends of the first clamp arms 326, 328 may be flared outward to form a chamfered lead-in to the first pocket 332. In an exemplary embodiment, the first pocket 332 may be elongated (for example, oval) in the mating direction to allow mating float of the first power pin 80 in the first pocket 332 in the mating direction (for example, front-to-rear float). The front-to-rear float allows mating tolerance between the power connector 200 and the power pins 80, 82.

In an exemplary embodiment, the first clamp arms 326, 328 define a clamp around the first socket 322 configured to receive and clamp to the first power pin 80. The clamp defined by the first clamp arms 326, 328 define a pluggable and separable mating interface with the first power pin 80. The first clamp arms 326, 328 extend forward from the base 324 on opposite sides of the gap 330. The gap 330 is open at the rear of the first power contact 300 to receive the first power pin 80 through such opening. The first clamp arms 326, 328 are flexible and configured to be deflected outward away from each other when mated to the first power pin 80 to provide a clamping force on the first power pin 80. For example, the first clamp arms 326, 328 squeeze inwardly on the first power pin 80 to create a reliable mechanical and electrical connection to the first power pin 80.

In an exemplary embodiment, the first clamp arms 326, 328 allow vertical float of the first power contact 300 relative to the first power pin 80. For example, the first socket 322 is open at the top and the bottom of the first power contact to allow the first power pin 80 to pass through the first socket 322 and allow vertical float relative to each other, such as for mating tolerance. In an exemplary embodiment, the first clamp arms 326, 328 allow horizontal float of the first power contact 300 relative to the first power pin 80. For example, the first pocket 332 may be elongated to allow the float in the mating direction (for example, front-to-rear). The first clamp arms 326, 328 are flexible to allow side-to-side movement, such as to accommodate side-to-side mating tolerance.

In an exemplary embodiment, the second power contact 302 is a stamped and formed contact. The second power contact 302 may be a multi-piece contact, such as having multiple stamped and formed parts that are mechanically and/or electrically connected together. The second power contact 302 includes a second mating end 350 and a second terminating end 360. The second power contact 302 includes spring beams 352, or other types of contacts, defining a mating interface 354 for mating with the busbar 110. The mating interface 354 may be provided proximate to the distal ends of the spring beams 352. The second power contact 302 may include one or more support contacts, such as an inner support contact 356 and an outer support contact 358 providing support for the spring beams 352. The inner support contact 356 and/or the outer support contact 358 may be connected by welding, soldering, conductive adhesive, fasteners, rivots, or other connecting techniques. The inner support contact 356 and/or the outer support contact 358 may have different thicknesses than the spring beams 352. The inner support contact 356 and/or the outer support contact 358 may have different lengths than the spring beams 352.

In an exemplary embodiment, the second power contact 302 includes a second socket 362 at the second terminating end 360. The second socket 362 receives the second power pin 82. In an exemplary embodiment, the second socket 362 is a separate part from the spring beam 352. For example, the second socket 362 may be mechanically and electrically connected to the spring beam 352, such as by welding, soldering, fastening, or attaching by other processes. In an exemplary embodiment, the socket 362 is a stamped and formed part. The socket 362 is stamped from a piece of sheet metal and may have a thickness selected to have a particular current rating and/or selected to have certain resiliency characteristics, such as to have a particular clamping force to ensure mechanical and electrical connection to the second power pin 82.

The second socket 362 includes a base 364 and second clamp arms 366, 368 extending from the base 364. The base 364 extends from the spring beam 352. For example, the base 364 may be coupled (for example, welded, soldered, fastened, or otherwise connected to the spring beam 352) to the spring beam 352. The second socket 362 forms a space or gap 370 between the second clamp arms 366, 368 configured to receive the second power pin 82. The gap 370 is located rearward of the base 364.

The second socket 362 forms a second pocket 372 in the gap 370 configured to receive the second power pin 82. The second pocket 372 may be sized and shaped to receive the second power pin 82. For example, the second pocket 372 may be circular or oval shaped to form a space configured to receive and retain the second power pin 82. The distal ends of the second clamp arms 366, 368 may be flared outward to form a chamfered lead-in to the second pocket 372. In an exemplary embodiment, the second pocket 372 may be elongated (for example, oval) in the mating direction to allow mating float of the second power pin 82 in the second pocket 372 in the mating direction (for example, front-to-rear float). The front-to-rear float allows mating tolerance between the power connector 200 and the power pins 82, 82.

In an exemplary embodiment, the second clamp arms 366, 368 define a clamp around the second socket 362 configured to receive and clamp to the second power pin 82. The clamp defined by the second clamp arms 366, 368 define a pluggable and separable mating interface with the second power pin 82. The second clamp arms 366, 368 extend forward from the base 364 on opposite sides of the gap 370. The gap 370 is open at the rear of the second power contact 302 to receive the second power pin 82 through such opening. The second clamp arms 366, 368 are flexible and configured to be deflected outward away from each other when mated to the second power pin 82 to provide a clamping force on the second power pin 82. For example, the second clamp arms 366, 368 squeeze inwardly on the second power pin 82 to create a reliable mechanical and electrical connection to the second power pin 82.

In an exemplary embodiment, the second clamp arms 366, 368 allow vertical float of the second power contact 302 relative to the second power pin 82. For example, the second socket 362 is open at the top and the bottom of the second power contact to allow the second power pin 82 to pass through the second socket 362 and allow vertical float relative to each other, such as for mating tolerance. In an exemplary embodiment, the second clamp arms 366, 368 allow horizontal float of the second power contact 302 relative to the second power pin 82. For example, the second pocket 372 may be elongated to allow the float in the mating direction (for example, front-to-rear). The second clamp arms 366, 368 are flexible to allow side-to-side movement, such as to accommodate side-to-side mating tolerance.

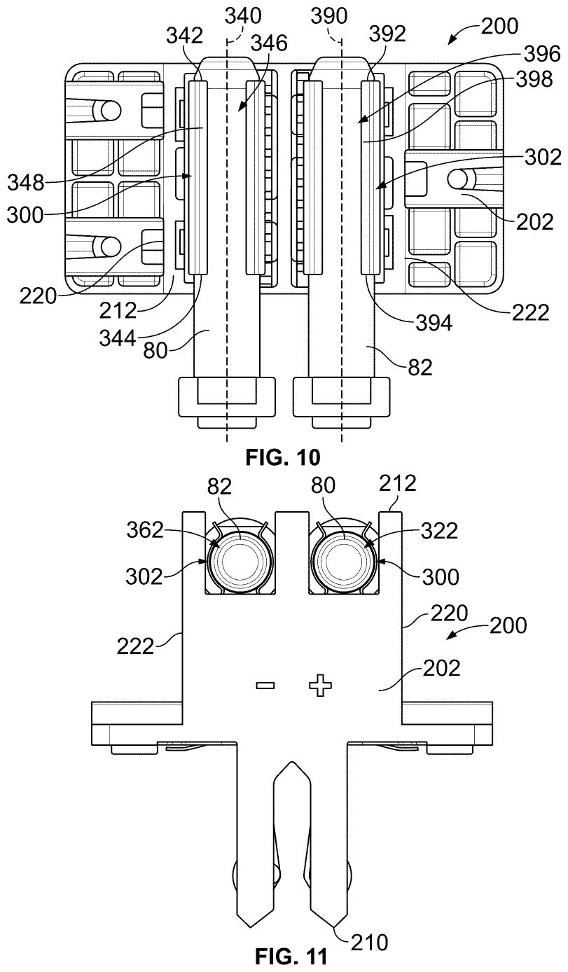

FIG. 10 is a rear view of the power connector 200 in accordance with an exemplary embodiment coupled to the first and second power pins 80, 82. FIG. 11 is a top view of the power connector 200 in accordance with an exemplary embodiment coupled to the first and second power pins 80, 82. In an exemplary embodiment, the components of the power connector 200 are contained within the footprint of the connector housing 202 (for example, defined between the front 210 and the rear 212 and between the first side 220 and the second side 222). The first and second power contacts 300, 302 are contained within the footprint. The power pins 80, 82 are located within the footprint. For example, the footprint completely encloses the first and second power pins 80, 82.

The first socket 322 extends along a first socket axis 340 between a top 342 and a bottom 344 of the first power contact 300. The first socket 322 includes an opening 346 at a rear 348 of the first power contact 300. The first socket 322 is configured to be pluggably coupled to the first power pin 80 in a mating direction perpendicular to the first socket axis 340. For example, the first socket axis 340 may extend vertically and the mating direction is horizontal (for example, front-to-rear). Optionally, the first power pin 80 may be elongated (for example, taller) to accommodate coupling of multiple power connectors 200 to the first power pin 80.

The second socket 362 extends along a second socket axis 390 between a top 392 and a bottom 394 of the second power contact 302. The second socket 362 includes an opening 396 at a rear 398 of the second power contact 302. The second socket 362 is configured to be pluggably coupled to the second power pin 80 in a mating direction perpendicular to the second socket axis 390. For example, the second socket axis 390 may extend vertically and the mating direction is horizontal (for example, front-to-rear). Optionally, the second power pin 82 may be elongated (for example, taller) to accommodate coupling of multiple power connectors 200 to the second power pin 82.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. § 112(f), unless and until such claim limitations expressly use the phrase “means for” followed by a statement of function void of further structure.

What is claimed is:

1. A power connector comprising:
a connector housing having a mating end at a front and a terminating end at a rear, the connector housing having a base at the terminating end and a plug, extending forward of the base, at the mating end, the plug configured to be plugged into a busbar assembly, the plug including a slot between a first plug wall and a second plug wall, the slot configured to receive a busbar of the busbar assembly, the connector housing having contact channels through the base and extending to the slot of the plug;
a first power contact received in the corresponding contact channel, the first power contact having a first mating end extending along the first plug wall into the slot to mate with a first busbar contact of the busbar, the first power contact having a first socket at the terminating end configured to receive a first power pin;
a second power contact received in the corresponding contact channel, the second power contact having a second mating end extending along the second plug wall into the slot to mate with a second busbar contact of the busbar, the second power contact having a second socket at the terminating end configured to receive a second power pin.

2. The power connector of claim 1, wherein the first and second sockets are open at the rear to receive the first and second power pins.

3. The power connector of claim 1, wherein the first power contact includes a first clamp forming the first socket configured to receive and clamp the first power pin, the second power contact includes a second clamp forming the second socket configured to receive and clamp the second power pin.

4. The power connector of claim 1, wherein the first power contact defines a pluggable and separable mating interface with the first power pin, the second power contact defines a pluggable and separable mating interface with the second power pin.

5. The power connector of claim 1, wherein the first power contact includes first clamp arms separated by a first gap defining the first socket, the first gap being open at a rear of the first power contact to receive the first power pin, the second power contact includes second clamp arms separated by a second gap defining the second socket, the second gap being open at a rear of the second power contact to receive the second power pin.

6. The power connector of claim 5, wherein the first clamp arms are flexible and configured to be deflected outward when mated to the first power pin to provide a clamping force on the first power pin, the second clamp arms are flexible and configured to be deflected outward when mated to the second power pin to provide a clamping force on the second power pin.

7. The power connector of claim 5, wherein the first clamp arms allow vertical float of the first power contact relative to the first power pin and allow horizontal float of the first power contact relative to the first power pin, the second clamp arms allow vertical float of the second power contact relative to the second power pin and allow horizontal float of the second power contact relative to the second power pin.

8. The power connector of claim 5, wherein the first clamp arms have a first pocket configured to receive the first power pin, the first pocket being elongated to allow mating float of the first power pin in the first pocket in a mating direction, the second clamp arms have a second pocket configured to receive the second power pin, the second pocket being elongated to allow mating float of the second power pin in the second pocket in a mating direction.

9. The power connector of claim 1, wherein the first socket extends along a first socket axis between a top and a bottom of the first power contact, the first socket including an opening at a rear of the first power contact to pluggably couple to the first power pin in a mating direction perpendicular to the first socket axis, the second socket extends along a second socket axis between a top and a bottom of the second power contact, the second socket including an opening at a rear of the second power contact to pluggably couple to the second power pin in a mating direction perpendicular to the second socket axis.

10. The power connector of claim 1, wherein the connector housing has a footprint, the footprint completely enclosing the first and second power pins.

11. The power connector of claim 1, wherein the connector housing includes first and second windows at the terminating end, the first and second sockets located in the first and second windows, respectively, the first and second windows configured to receive the first and second power pins, respectively.

12. The power connector of claim 11, wherein the first and second windows are open at a top and a bottom of the connector housing to allow the first and second power pins to extend from the top and the bottom, the first and second windows being open at the rear to receive the first and second power pins into the first and second windows through the rear in a plugging direction.

13. A data communication system comprising:
a data rack having a rack space;
an equipment tray received in the rack space, the equipment tray including a circuit board, the equipment tray including a first power pin and a second power pin coupled to the circuit board;
a power supply device coupled to the data rack to supply power to the equipment tray, the power supply device including a shroud forming a busbar chamber and a busbar received in the busbar chamber; and
a power connector including a connector housing holding a first power contact and a second power contact, the connector housing having a mating end at a front and a terminating end at a rear, the connector housing having a base at the terminating end and a plug, extending forward of the base, at the mating end, the plug configured to be plugged into a busbar assembly, the plug including a slot between a first plug wall and a second plug wall, the slot configured to receive a busbar of the busbar assembly, the connector housing having contact channels through the base and extending to the slot of the plug, the first power contact received in the corresponding contact channel, the first power contact having a first mating end extending along the first plug wall into the slot to mate with a first busbar contact of the busbar, the first power contact having a first socket at the terminating end mated to the first power pin, the second power contact received in the corresponding contact channel, the second power contact having a second mating end extending along the second plug wall into the slot to mate with a second busbar contact of the busbar, the second power contact having a second socket at the terminating end mated to the second power pin.

14. The data communication system of claim 13, wherein the busbar includes a support panel, a first busbar element extending along a first side of the support panel, and a second busbar element extending along a second side of the support panel.

15. The data communication system of claim 13, further comprising:
a second equipment tray received in the rack space, the second equipment tray including a second circuit board, the second equipment tray including a first power socket coupled to the second circuit board and a second power socket coupled to the second circuit board, the first power socket receiving the first power pin, the second power socket receiving the second power pin; and
a second power connector including a second connector housing holding a first power contact and a second power contact, the second connector housing having a mating end at a front and a terminating end at a rear, the second connector housing having a base at the terminating end and a plug, extending forward of the base, at the mating end, the second connector housing having contact channels through the base and the plug of the second power connector holding the first and second power contacts of the second power connector, the first power contact of the second power connector having a first socket at the terminating end of the second power connector mated to the first power pin, the second power contact of the second connector housing having a second socket at the terminating end of the second connector housing mated to the second power pin.

16. The data communication system of claim 13, wherein the first and second sockets are open at the rear to receive the first and second power pins.

17. The data communication system of claim 13, wherein the first power contact includes a first clamp forming the first socket configured to receive and clamp the first power pin, the second power contact includes a second clamp forming the second socket configured to receive and clamp the second power pin.

18. The data communication system of claim 13, wherein the first power contact includes first clamp arms separated by a first gap defining the first socket, the first gap being open at a rear of the first power contact to receive the first power pin, the second power contact includes second clamp arms separated by a second gap defining the second socket, the second gap being open at a rear of the second power contact to receive the second power pin.

19. The data communication system of claim 13, wherein the connector housing includes first and second windows at the terminating end, the first and second sockets located in the first and second windows, respectively, the first and second windows configured to receive the first and second power pins, respectively, the first and second windows are open at a top and a bottom of the connector housing to allow the first and second power pins to extend from the top and the bottom, the first and second windows being open at the rear to receive the first and second power pins into the first and second windows through the rear in a plugging direction.

20. A data communication system comprising:
a data rack having a rack space;
an equipment tray received in the rack space, the equipment tray including a circuit board, the equipment tray including a first power pin and a second power pin coupled to the circuit board;
a power supply device coupled to the data rack to supply power to the equipment tray, the power supply device including a shroud forming a busbar chamber and a busbar received in the busbar chamber; and
a power connector including a connector housing holding a first power contact and a second power contact, the connector housing having a mating end at a front and a terminating end at a rear, the mating end of the connector housing forming an open rack power connector interface for mating with a busbar assembly, the first power contact having a first socket at the terminating end mated to the first power pin, the second power contact having a second socket at the terminating end mated to the second power pin.
